(19) United States
(12) Patent Application Publication
(10) Pub. No.: US 2011/0303031 A1
(43) Pub. Date: Dec. 15, 2011

(54) Linear sail control system based upon screw forms

(76) Inventor: William Steven Kroll, Houston, TX (US)

(21) Appl. No.: 12/802,767

(22) Filed: Jun. 14, 2010

(51) Int. Cl. F16H 25/20

(52) U.S. Cl. 74/89.39; 74/89.23

(57) ABSTRACT

A novel apparatus and method of controlling sails and their related mechanical forces on sailing systems through the utilization of threaded elements/forms. This device is easily scaled to the requirements of the particular sailing system being controlled. It has four basic elements providing control. The first is a rotatable lead screw having a lead angle of 5° or less. A matching internally threaded element, which travels in a linearly upon the lead screw when same is rotated. The lead screw may have non-threaded smooth sections on each end, which provide an area for rotary bearing supports. Rotation of the lead screw is provided for upon either or both ends.

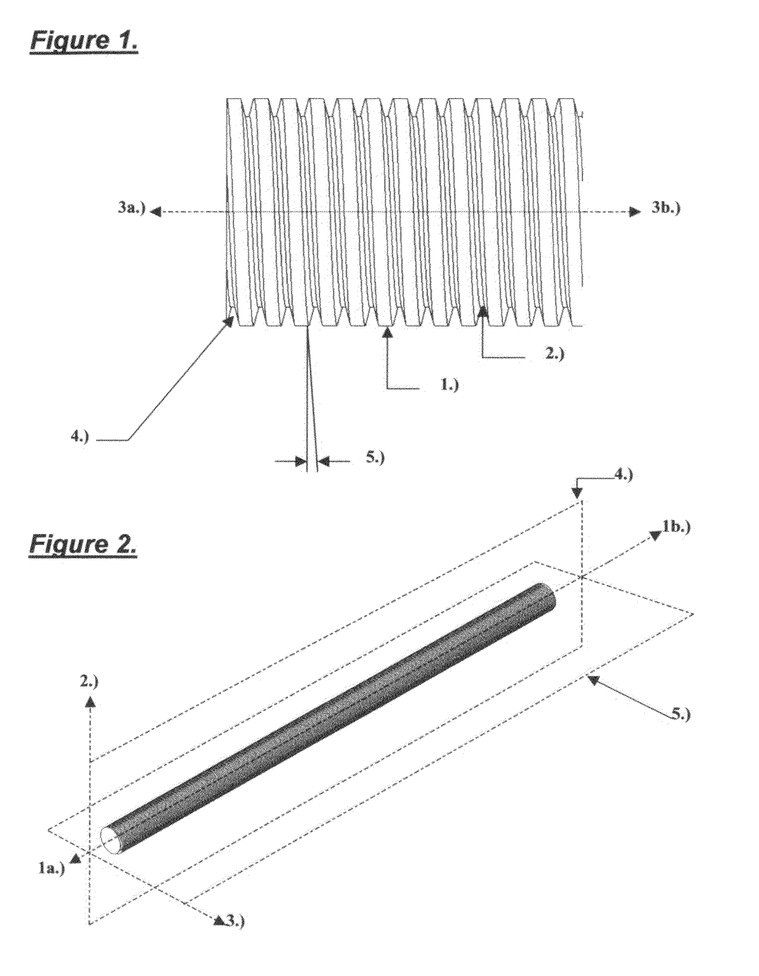

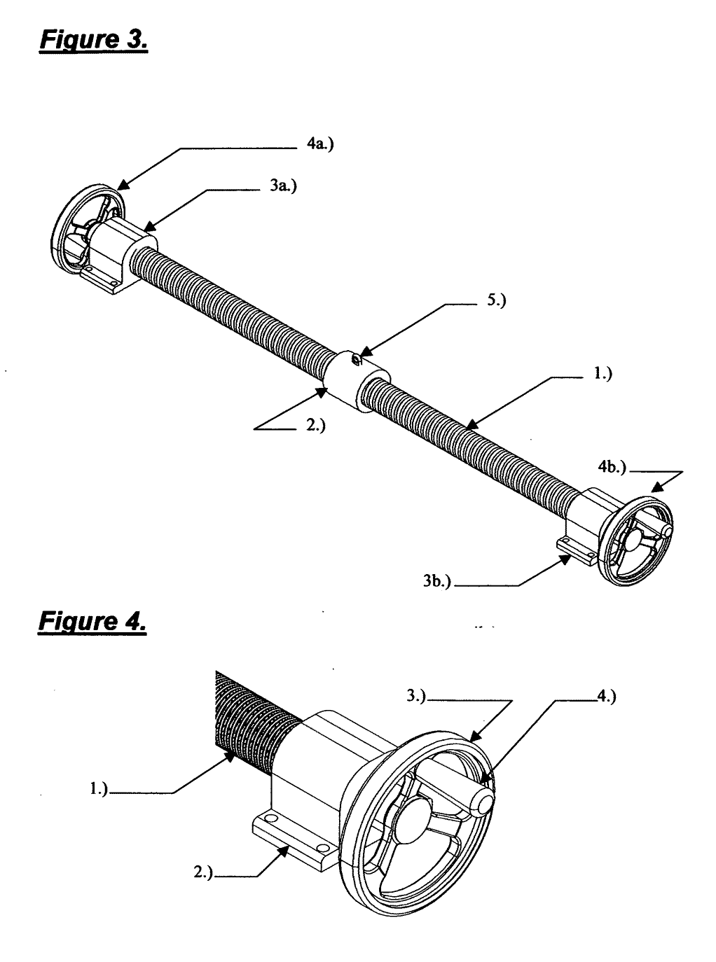

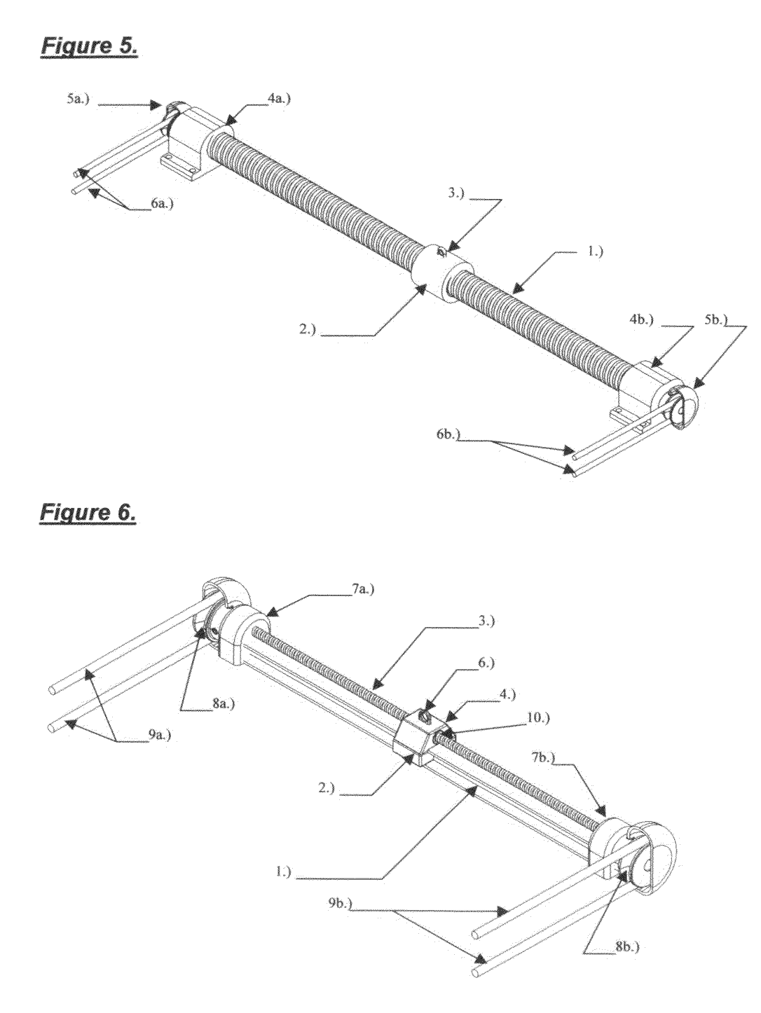

The lead screw may be of any form or design provided it has a lead angle of 5° or less. This feature eliminates the need for brakes or other holding devices to sustain loads after they have been positioned.

### BACKGROUND OF THE INVENTION

This invention relates to the control of sails on vessels, particularly the linear control of these systems and their related elements. The most common form of linear control systems on sailing vessels are, to those familiar in the art, is commonly referred to as a traveler system.

The mainsail traveler system is a method of linear athwartship control of the mainsail. It positions the boom of the vessel at a direction at right angles to the longitudinal axis of the vessel.

Travelers are also used along the (primarily) longitudinal axis of vessels for the control of other sails, but is not limited to, such as the jib, genoa and spinnaker. These sails and/or elements of their controls may also employ athwartship travelers.

Previous examples of sail control systems, especially the mainsail traveler, typically use an athwartship mounted track upon which a car slides or rolls. Said car position upon the track is typically controlled by a combination or series of lines, pulleys, cams, cleats and or clutches.

To overcome the loads exerted by the sails, current systems often utilize a series of pulleys and lines to provide the user with a mechanical advantage. Said systems, often require two sets of pulleys and lines in order to provide bi-directional control along the track. While it may be stated that only one side, the windward side, must be adjusted for each change in traveler car direction, in practice, the opposite control is also adjusted and fixed in position. This action is performed so that the system is prepared for the next change in linear direction.

Other known designs of linear motion sail controls on vessels utilize cams, cleats or clutches to secure the lines on either end of the track to hold the position of the traveler car upon the track. While many of these systems are effective, their required duality of securing and braking systems is inefficient and difficult to operate under high loads and/or adverse conditions.

My new design overcomes the many drawbacks of previous designs, as described, in this writing with an improved and much simpler design. My new design eliminates the need for pulley systems to create mechanical advantage for the user as said mechanical advantage is inherent in the screw drive. The mechanical advantage of a leadscrew is determined by the screw pitch and lead. Further, the need for braking mechanisms such as cams, cleats and clutches are no longer required because the low lead threaded screw form such as Acme or Trapezoidal screw utilized, is self braking. A further advantage is that there is no requirement for duplication of user controls, though, that may be desirable in certain applications for ease of access, commonly referred to as ergonomics.

### FIELD OF INVENTION

The present invention relates to sailing control systems. Specifically, it is a means of imparting bi-directional linear motion and braking action with respect to sail systems through the utilization of threaded elements. The mechanical systems associated with this system, as described herein, should be familiar to those knowledgeable in the art.

### SUMMARY OF THE INVENTION

Applicant's invention allows for an efficient method of the control of sailing systems through the utilization of a low lead angle male screw form and its corresponding female threaded counterpart. The screw form utilized may be of the type which possesses a lead angle of 5° or less. This type of screw form is typified by the Acme inch dimensioned thread or a Trapezoidal thread, its metric equivalent. The pitch of the Acme being 29° and the Trapezoidal at 30°, they share a robust and easily formed and/or machined profile as well as the required lead angle of 5° or less. Said specifications produce a high load carrying capacity, high mechanical advantage and a self-braking reaction to external sail system loads.

The invention described herein utilizes the screw as a means of imparting linear motion and control to sailing systems. As described, said screw may be scaled in accordance with the loads that the system will be subjected to in its specific sail control application.

The screw may be scaled for the linear control of existing or hybrid traveler systems wherein the primary axial loads are supported by a traveler system of conventional design. These are most commonly referred to as a track and car wherein the track may be of such a form that it may mate with a car. Said car may equipped with bearings or bushings which facilitate load carrying across the length of the track. In my invention, the screw and its related nut form are used to position and brake the car along the Z axis of the track. The screw may be scaled so that both axial and radial loads are carried solely by the screw and its related nut. Said screw may be supported by any combination anti-friction elements to facilitate its efficient free rotation, which shall also be scaled to support the design loads of the specific system. Whether the system is utilized as the prime carrier or as a part of a hybrid system, a means of imparting rotation to the screw, and therefore, the corresponding linear control of the sail control system, is required. This may be of a manual, meaning human powered, kinetic, electrical, pneumatic, magnetic or hydraulic nature. It may use any combination of aforementioned means of power input which may be used with or without a means of mechanical speed reduction or speed increasing mechanisms.

What is claimed is:

1. An improved apparatus and method for sail system control which utilizes a male threaded screw, freely rotatable upon its Z axis, and a nut with a female thread form, substantially matching the thread form of the male screw for controlling the linear motion of elements in a sailing system.

2. The combination of elements as described in claim 1, wherein the male screw being utilized possesses an external thread form. Said thread form may have a lead angle of 5° or less and/or other design characteristics which provide the combination of the screw with a nut riding upon it with a self-braking nature and/or being resistant to back-driving.

3. The combination as claimed in claim 2, wherein the nut shall traverse the screw in a manner which is, primarily parallel to the screw's Z axis. The nut's direction of travel along the screw is determined by the direction of Z axis rotation of the screw. That is the rotation of the screw, upon its Z axis, may be described as being either clockwise or counter-clockwise.

4. The combination as claimed in claim 3, wherein the nut may be equipped with a means of attaching lines, cords or other hardware attachments to an external element or elements which may be part of a sailing system or a portion thereof.

5. The combination as described in claim 3, wherein the nut may be contained within a housing, and said housing may be equipped with a hardware means of attaching same to external elements controlling sail systems or a portion thereof.

6. The combination as claimed in claim 3, wherein the nut, whether contained in a housing or not, may be attached to a track which is substantially parallel to the Z axis of the screw. Radial loads exerted upon the invention by the sailing system, or elements or portions thereof, are carried, primarily, by a car which may slide or roll upon the track element. The nut riding upon the screw is directly or indirectly attached to the car which is riding upon and/or within the track. The nut shall carry, primarily, axial loads exerted by the sailing system and elements, or portions thereof, to which it is attached.

7. The combination as described in claim 3, wherein the screw is supported with anti-friction bearings.

8. The combination as described in claim 6, wherein the screw is equipped with a means of imparting rotation to the screw.

9. The combination as described in claim 5, wherein the lead screw is supported with anti-friction bearings.

9. The combination as described in claim 8, wherein the lead screw is equipped with a means of imparting radial motion to the screw.

10. The combination as described in claim 9, wherein the means of imparting radial motion to the screw may be either parallel or perpendicular as it relates to the primary threaded Z axis of said screw.

11. The combination as described in claim 10, wherein the device or means of imparting radial motion to the screw may be of a design or possessing a means of altering the rotational input speed and/or torque of the primary energy input device.

12. The combination as described in claim 11, wherein the primary mover, that is the means of imparting radial motion to the screw upon it's Z axis, may be of a manual, kinetic, magnetic, pneumatic, electric, hydraulic or other nature. Said means of energy input may be a combination of any of these aforementioned means.

13. The combination as described in claim 12, wherein the controls of the primary mover or input energy may be local or remote in nature.

14. The combination described in claim 12, wherein the primary mover may be directly or indirectly coupled to the screw. Said directional orientation of the primary mover may be primarily perpendicular or parallel to the Z axis of the screw.
